(19) United States
(12) Patent Application Publication
(10) Pub. No.: US 2024/0320659 A1
(43) Pub. Date: Sep. 26, 2024

(54) SYSTEM AND METHOD FOR PROVISIONING MOBILE CREDENTIALS WITH MULTI-WALLET AND DEVICE SELECTOR

(71) Applicant: TRANSACT CAMPUS INC., SCOTTSDALE, AZ (US)

(72) Inventors: CORMAC REIDY, LIMERICK (IE); COLLEN NQABUTHO NDLOVU, LISTOWEL (IE); PRAVEEN TALARI, KILDARE TOWN (IE); REESE MCLEAN, PHOENIX, AZ (US); SHANE O'CONNOR, LISTOWEL (IE); RAGHU RUDRA, SCOTTSDALE, AZ (US); RAMANDEEP ARORA, APEX, NC (US); DIETMAR GLENN TONN, OOLTEWAH, TN (US); DUANE TERRAZAS, SCOTTSDALE, AZ (US)

(21) Appl. No.: 18/735,852

(22) Filed: Jun. 6, 2024

Related U.S. Application Data
(63) Continuation-in-part of application No. 18/196,067, filed on May 11, 2023.
(60) Provisional application No. 63/446,559, filed on Feb. 17, 2023.

(51) Int. Cl. G06Q 20/36

(52) U.S. Cl. CPC G06Q 20/3674

(57) ABSTRACT

A system and method for provisioning mobile credentials in digital wallets of mobile devices is disclosed. Each mobile device executes a mobile application programmed to identify a plurality of digital wallets available for use on the mobile device, display a user interface that presents a plurality of digital wallet options each of which corresponds to one of the identified digital wallets, and receive a selection of a digital wallet from the digital wallet options. The mobile application then creates mobile credential data that enables provisioning of a mobile credential in the selected digital wallet of the mobile device. In some embodiments, the mobile application may also be programmed to enable selection of the device onto which the mobile credential will be provisioned.

### CROSS-REFERENCE TO RELATED APPLICATIONS

This application is a continuation-in-part of and claims priority to U.S. patent application Ser. No. 18/196,067 filed on May 11, 2023, which is based on and claims priority to U.S. Provisional Patent Application No. 63/446,559 filed on Feb. 17, 2023, both of which are incorporated herein by reference in their entireties.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

Electronic account management systems enable users to manage electronic accounts via mobile applications on their mobile devices. Some of these mobile applications are designed for use by users associated with different institutions and associated service portals. In practice, the mobile application prompts the user to select an institution, select a service portal, and enter login credentials (e.g., username and password). Once logged in, the user is presented with an interface that enables the user to perform a number of different tasks associated with the selected institution and service portal, such as deposit money into an account, view an account balance, pay for purchases, or add a mobile credential to a digital wallet of the user's mobile device. While these mobile applications have been widely adopted, they do have certain drawbacks. For example, most mobile applications are configured to provision a mobile credential into a designated digital wallet of a user's mobile device, wherein the digital wallet may not be preferred by particular users. Thus, there remains a need in the art for technological solutions that overcome these drawbacks and/or that offer other advantages compared to existing mobile applications used by electronic account management systems.

### BRIEF SUMMARY OF THE INVENTION

The present invention is directed to a system and method for provisioning mobile credentials in digital wallets of mobile devices. In some embodiments, each mobile device executes a mobile application programmed to provide a plurality of digital wallet options and receive a selection of a digital wallet from the digital wallet options. The mobile application then creates mobile credential data that enables provisioning of a mobile credential in the selected digital wallet of the mobile device. In other embodiments, the mobile application enables selection of a digital wallet (as just described) and is also programmed to provide a plurality of device options and receive a selection of a device from the device options. The mobile application then creates mobile credential data that enables provisioning of a mobile credential in the selected digital wallet of the selected device.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various exemplary embodiments of the present invention is provided below with reference to the following drawings, in which:

FIG. 1 is a network diagram of one embodiment of a system for provisioning mobile credentials in selected digital wallets of mobile devices in accordance with the invention;

FIG. 2 is a block diagram of the mobile credential management system shown in FIG. 1;

FIGS. 3A-3B depict a process flow diagram of an exemplary method for provisioning mobile credentials via use of a mobile application executed on the mobile devices shown in FIG. 1; and

FIGS. 4-13 depict exemplary screen shots of one of the mobile devices shown in FIG. 1 during execution of the mobile application in accordance with the method shown in FIGS. 3A-3B.

### DETAILED DESCRIPTION OF EXEMPLARY EMBODIMENTS

The present invention is directed to a system and method for provisioning mobile credentials in selected digital wallets of mobile devices. While the invention will be described in detail below with reference to various exemplary embodiments, it should be understood that the invention is not limited to the specific configuration or methodologies of any of these embodiments. In addition, although the exemplary embodiments are described as embodying several different inventive features, one skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

In general terms, the system and method of the present invention utilizes a mobile application that enables a mobile credential to be provisioned in a selected digital wallet of one or more mobile devices. Each mobile credential comprises a unique identifier that may comprise, for example, an electronic identification (ID) card that is used for access control (e.g., unlocking doors) and/or payments from a stored value account (e.g., pre-paid meal plans or other prepaid goods and services). As described below, the mobile application is programmed to (a) determine the digital wallet options (e.g., wallet A, wallet B, wallet C, etc.) and mobile device options (e.g., mobile phone, wearable computing device, etc.) that are available for a particular user and mobile device, (b) provide a user interface that presents such options for selection by the user, and (c) cause the mobile credential to be provisioned in the selected digital wallet of the selected one or more mobile devices.

In some embodiments, the mobile application comprises a full mobile application that may be downloaded from an application store and installed on the user's mobile device. The full mobile application is programmed to present a user interface that enables the user to perform a plurality of different tasks, such as deposit money into an account, view an account balance, pay for purchases, and/or add a mobile credential to a selected digital wallet of one or more mobile devices in accordance with the present invention.

In other embodiments, the mobile application comprises a micro application that is programmed to perform a single task-add a mobile credential-without requiring the user to download and install the full mobile application on the user's mobile device. Because of its limited functionality, the size of the micro application is significantly smaller than that of the full mobile application, e.g., the micro application's uncompressed size is preferably 20 megabytes or less, more preferably 15 megabytes or less, and most preferably 10 megabytes or less. Users may use their mobile devices to launch and load the micro application in different ways, as described in U.S. patent application Ser. No. 18/196,067 filed on May 11, 2023 and titled “System and Method for Provisioning Mobile Credentials,” which is owned by the assignee of the present application and incorporated herein by reference in its entirety.

In some embodiments, the mobile application is configured for use by users associated with a specific institution. For example, a first mobile application may be used by users associated with Institution A, a second mobile application may be used by users associated with Institution B, a third mobile application may be used by users associated with Institution C, etc. In this case, each user may open the applicable mobile application and enter his login credentials (e.g., username and password) in order to begin the process of provisioning a mobile credential in a selected digital wallet of one or more mobile devices.

In other embodiments, the same mobile application is configured for use by users associated with a plurality of different institutions—e.g., Institution A, Institution B, Institution C, etc. In this case, each user may open the mobile application, select an institution and optionally a service portal, and enter his login credentials (e.g., username and password) in order to begin the process of provisioning a mobile credential in a selected digital wallet of one or more mobile devices.

An exemplary embodiment of the present invention will now be described in which a full mobile application is configured for use by users associated with a plurality of different institutions. It should be understood that this embodiment is provided in order to describe the various capabilities of the invention and not to limit the scope of the invention. For example, the invention may alternatively be implemented via a micro application or via a mobile application (full mobile application or micro application) configured for use by users associated with a specific institution. Other embodiments will be apparent to one skilled in the art.

### Mobile Credential Provisioning System

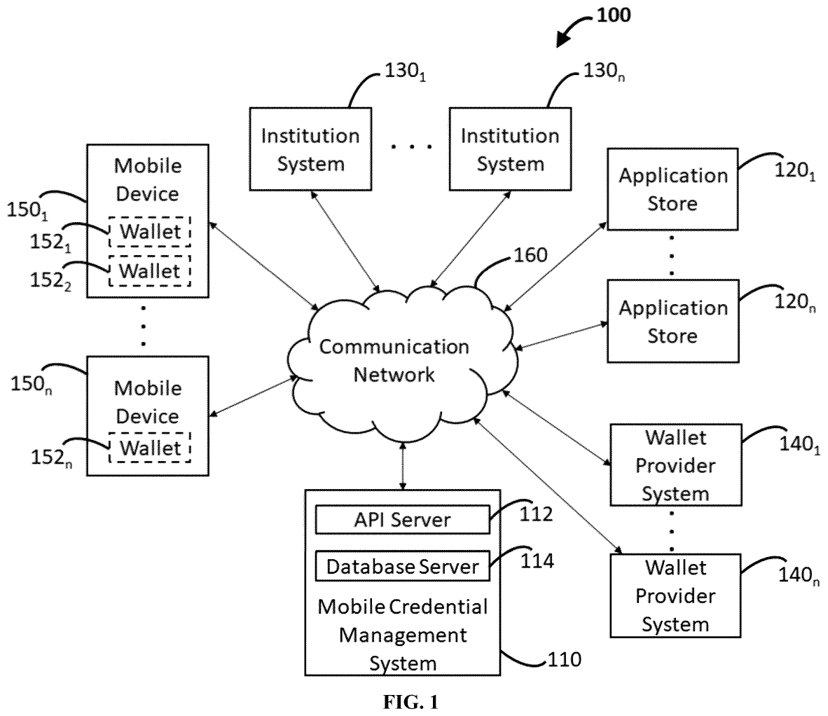

Referring to FIG. 1, one embodiment of a system for provisioning mobile credentials in selected digital wallets of mobile devices in accordance with the present invention is shown generally as reference number 100. System 100 includes a plurality of network elements—including a mobile credential management system 110, a plurality of application stores 120₁-120ₙ, a plurality of institution systems 130₁-130ₙ, a plurality of digital wallet provider systems 140₁-140ₙ, and a plurality of mobile devices 150₁-150ₙ—which communicate with each other via a communication network 160, as described in greater detail below.

In this embodiment, mobile credential management system 110 comprises an API server 112 in communication with a database server 114. Mobile credential management system 110 is accessible by each of mobile devices 150₁-150ₙ via communication network 160. As discussed below, each mobile device executes a mobile application that includes a plurality of application programming interfaces (APIs) that send data requests to API endpoints of API server 112, and API server 112 responds by providing data that enables the mobile application to facilitate the provisioning of a mobile credential in a selected digital wallet of the mobile device and optionally at least one other mobile device (e.g., a wearable device) associated with the mobile device.

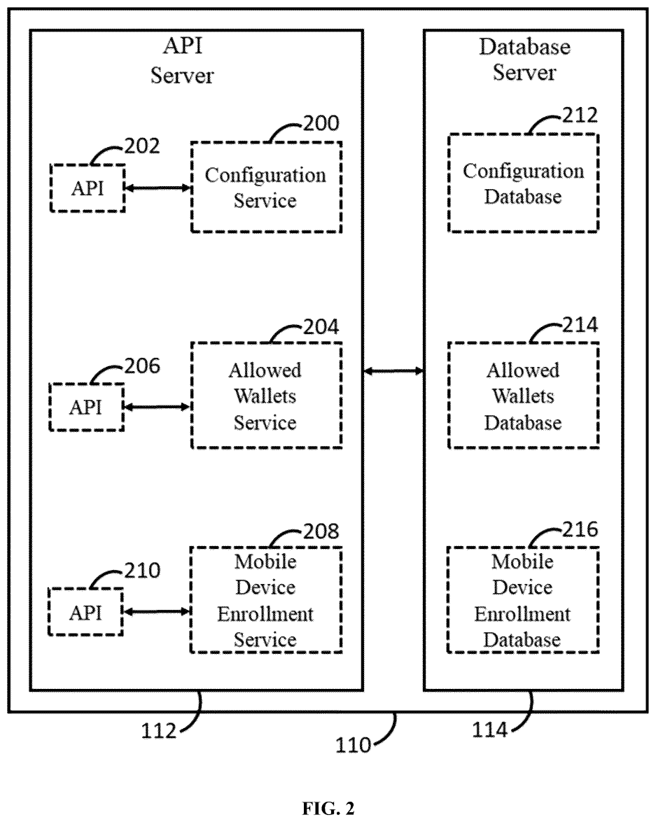

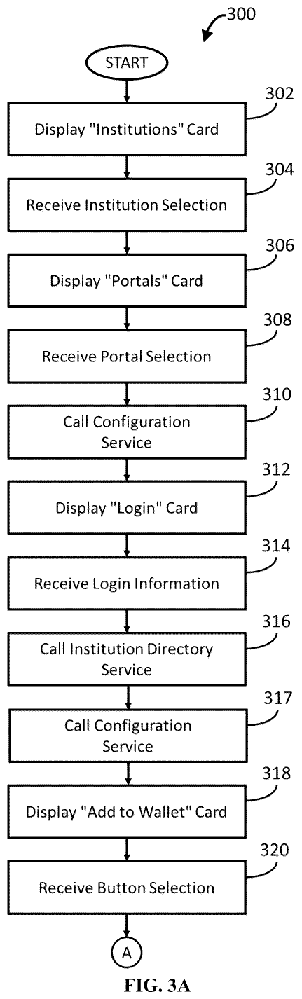

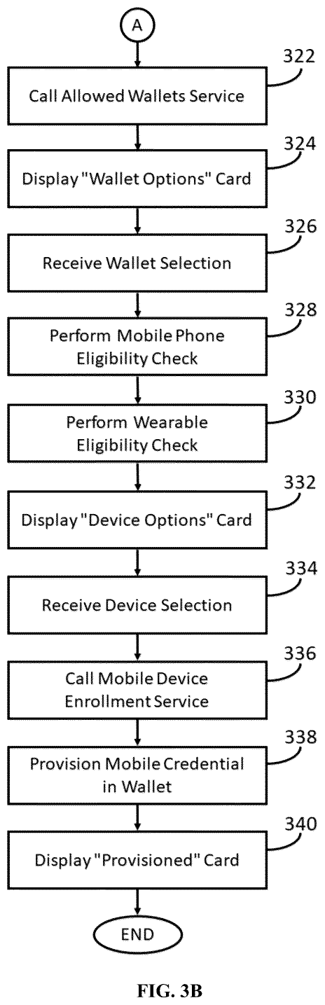

As shown in FIG. 2, API server 112 provides access to a number of different microservices that can be accessed through API endpoints, including a configuration service 200 that is accessible through API endpoint 202, an allowed wallets service 204 that is accessible through API endpoint 206, and a mobile device enrollment service 208 that is accessible through API endpoint 210. The functionality provided by these services will be described below in connection with the process flow chart of FIG. 3. Database server 114 maintains a number of different databases accessible by API server 112, including: (1) a configuration database 212 that stores (a) configuration information for each of a plurality of institutions (including an identity service provider responsible for authenticating users, a configuration set that identifies customized content for the institution, and an indication of whether the institution is eligible for the mobile credential service) and (b) configuration information for each of a plurality of users (including an indication of whether the user is eligible for the mobile credential service); (2) an allowed wallets database 214 that stores wallet information for each of a plurality of device types and optionally each of a plurality of institutions; and (3) a mobile device enrollment database 216 that stores information required to create a secure bundle of information needed to provision a mobile credential for each of a plurality of digital wallets and device types. Of course, one skilled in the art will appreciate that other types of data and data structures may be used within the scope of the present invention.

In this embodiment, API server 112 and database server 114 are co-located in the same geographic location. It should be understood, however, that these servers could be located in different geographic locations and connected to each other via communication network 160. It should also be understood that other embodiments may include a single server instead of API server 112 and database server 114. Further, other embodiments may include additional servers that are not shown in FIG. 1, e.g., one or more of the various services and associated databases could be provided on separate servers. Thus, the system may be implemented with any number and combination of servers, including API servers, database servers, web servers, and application servers, which are either co-located or geographically dispersed.

Referring back to FIG. 1, application stores 120₁-120ₙ each comprise a digital distribution platform capable of storing and distributing mobile applications to mobile devices-including the mobile application of the present invention that is programmed to cause a mobile credential to be provisioned in a selected digital wallet of one or more mobile devices. Examples of suitable application stores include the App Store® maintained by Apple Inc. of Cupertino, California (which stores and distributes both full mobile applications and micro applications (i.e., App Clips™) to mobile devices), the Google Play™ store maintained by Google Inc. of Mountain View, California (which stores and distributes both full mobile applications and micro applications (i.e., Instant Apps™) to mobile devices), and the Galaxy Store® maintained by Samsung Electronics Co., Ltd. of South Korea (which stores and distributes full mobile applications to mobile devices). Of course, other application stores may be used within the scope of the present invention (or the system may include a single application store in some embodiments).

In this embodiment, the mobile application comprises a full mobile application configured for use by users associated with a plurality of different institutions. To access the full mobile application, a user must access one of application stores 120₁-120ₙ to locate the mobile application and then download and install the mobile application on the user's mobile device. The mobile application then prompts the user to select an institution, select a service portal, and enter login credentials (e.g., username and password). Once logged in, the user is presented with an interface that enables the user to perform a plurality of different tasks, such as deposit money into an account, view an account balance, pay for purchases, and/or add a mobile credential to a selected digital wallet of one or more mobile devices in accordance with the present invention. Of course, one or more of application stores 120₁-120ₙ may also store a micro application that is associated with the full mobile application, wherein the micro application also enables users to add a mobile credential as described herein.

Referring back to FIG. 1, institution systems 130₁-130ₙ are each operated and managed by a different institution. For example, institution system 130₁ may be associated with Institution A and institution system 130ₙ may be associated with Institution N. Each of institution systems 130₁-130ₙ exposes an API endpoint that may be called by the mobile application installed on a mobile device in order to authenticate the login credentials entered by a user during the login process, as described below. It should be understood that system 100 will include an institution system for each institution participating in the system. Thus, system 100 may include tens, hundreds or thousands of institution systems (or more) in accordance with the present invention.

Referring still to FIG. 1, digital wallet provider systems 140₁-140ₙ each comprise a third party platform capable of supporting the provisioning of mobile credentials in the digital wallets of mobile devices. Examples of suitable digital wallet provider systems include the mobile credential provisioning system for Apple Wallet® maintained by Apple Inc. of Cupertino, California, the mobile credential provisioning system for Google Wallet® maintained by Google Inc. of Mountain View, California, the mobile credential provisioning system for Samsung Wallet™ maintained by Samsung Electronics Co., Ltd. of South Korea, the mobile credential provisioning system for Garmin Pay™ maintained by Garmin Ltd. of Olathe, Kansas, and the mobile credential provisioning system for Fitbit Pay™ maintained by Fitbit Inc. of San Francisco, California. Of course, other digital wallet provider systems may be used within the scope of the present invention (or the system may include a single digital wallet provider system in some embodiments).

Referring still to FIG. 1, mobile devices 150₁-150ₙ are used by users associated with one of institution systems 130₁-130ₙ. In this embodiment, the users comprise individuals who have a need to execute the mobile application in order to provision mobile credentials associated with the institutions in the selected digital wallets of their mobile devices. Examples of mobile devices that are suitable for use with the present invention include mobile phones (e.g., smart phones), wearable computing devices (e.g., smart watches), and personal computing tablets, which support execution of the mobile application and the storage and use of mobile credentials.

Each of mobile devices 150₁-150ₙ comprises a computing device that includes memory in data communication with at least one processor, wherein the memory stores at least one computer program comprising instructions that, when executed by the processor, cause the processor to download, install and execute the full mobile application distributed by one of application stores 120₁-120ₙ, as described below in connection with the process flow chart of FIG. 3. Each mobile device also includes one or more digital wallets and associated wallet software, each of which provides a secure element for storing a mobile credential and enabling use of that stored mobile credential to conduct contactless transactions (e.g., wireless communication with near field communication devices).

The digital wallets and associated wallet software for mobile devices 150₁-150ₙ are shown in FIG. 1. In this example, mobile device 150₁ includes two digital wallets and associated wallet software 152₁ and 152₂ and mobile device 150ₙ includes one digital wallet and associated wallet software 152ₙ. Of course, it should be understood that each of mobile devices 150₁-150ₙ may include any number of digital wallets and associated wallet software in accordance with the present invention.

Communication network 160 may comprise any network or combination of networks capable of facilitating the exchange of data among the network elements of system 100. In some embodiments, communication network 160 enables communication in accordance with one or more cellular standards, such as the Long-Term Evolution (LTE) standard, the Universal Mobile Telecommunications System (UMTS) standard, and the like. In other embodiments, communication network 160 enables communication in accordance with the IEEE 802.3 protocol (e.g., Ethernet) and/or the IEEE 802.11 protocol (e.g., Wi-Fi). Of course, other types of networks may also be used within the scope of the present invention.

### Mobile Credential Provisioning Method

Referring to FIG. 3, an exemplary method of executing a mobile application that is programmed to cause a mobile credential to be provisioned in a selected digital wallet of one or more mobile devices is shown generally as reference number 300. The method includes the steps performed by the mobile application when downloaded, installed and executed on one of the mobile devices shown in FIG. 1 (a mobile phone in this example). It will be seen that, during execution of the mobile application, the mobile device calls various services provided on mobile credential management system 110 (including a configuration service 200, an allowed wallets service 204, and a mobile device enrollment service 208), and also exchanges messages with one of institution systems 130₁-130ₙ and one of digital wallet provider systems 140₁-140ₙ. Of course, it should be understood that these same steps may be performed by the mobile application when executed on each of the mobile devices shown in FIG. 1.

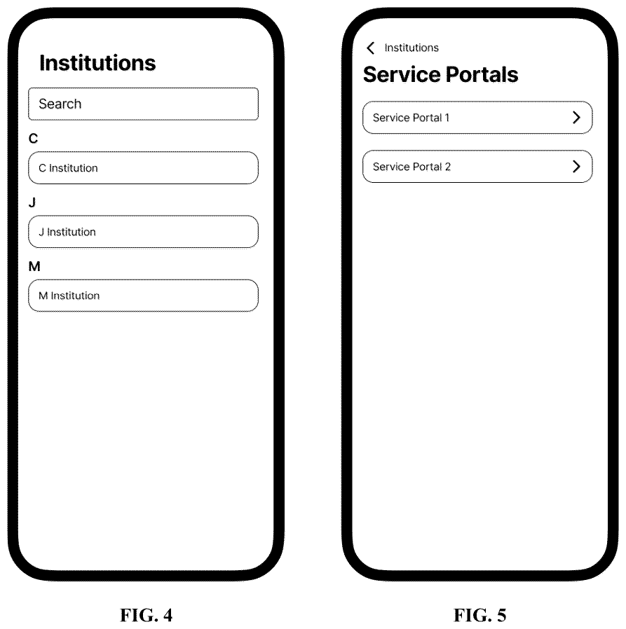

In step 302, the mobile application causes the mobile device to display a user interface that lists the institutions that can be selected by the user. An example of such a user interface is the card shown in FIG. 4, which enables easy selection of an institution through a search tool or alphabetical lists of institution names. Of course, one skilled in the art will appreciate that the list of institutions may be presented in other ways. In step 304, the user selects one of the institutions listed in FIG. 4, whereby the mobile application receives the institution selection.

In step 306, the mobile application causes the mobile device to display a user interface that lists the service portals associated with the selected institution. For example, if the institution is a university, the service portals may comprise a first service portal for students and a second service portal for employees (faculty, staff, etc.). Some institutions may only have a single service portal, in which case only one service portal will be displayed for selection by the user (or the service portal may not be presented at all). An example of such a user interface is the card shown in FIG. 5, which enables a user to select between “Service Portal 1” and “Service Portal 2.” Of course, one skilled in the art will appreciate that the service portal options may be presented in other ways. In step 308, the user selects one of the service portals listed in FIG. 5, whereby the mobile application receives the service portal selection.

In this embodiment, the selected institution and service portal are associated with an identifier comprising an institution/service portal tuple, i.e., a tuple with a first numeric value that identifies the institution and a second numeric value that identifies the service portal. Of course, in other embodiments, the identifier may only include a numeric value that identifies the institution (i.e., in cases where there is no service portal) or may include any other information required by a particular institution.

In step 310, the mobile application uses an API to pass the institution/service portal tuple to API endpoint 202 of configuration service 200 shown in FIG. 2. Configuration service 200 receives the institution/service portal tuple from the mobile device and accesses configuration database 212 to retrieve a configuration set corresponding to the institution/service portal tuple. The configuration set may include different types of information.

In one aspect, the configuration set identifies information on an identity service provider responsible for authenticating users associated with the institution during the login process. For example, the configuration set may include an ID of the identity service provider and/or a URL of the identity service provider to enable transmission of authentication requests to the identity service provider, as described below. In this embodiment, it will be seen that the identity service provider is an institution directory service operated by the institution.

In another aspect, the configuration set identifies customized content for the institution. For example, the configuration set may include an ID of the institution that can be used to retrieve customized content from another database—wherein the customized content may be retrieved either by configuration service 200 and passed back to the mobile application or by the mobile application itself. Alternatively, all or a portion of the customized content may be provided as part of the configuration set. The customized content may include, for example, the name and/or logo of the institution (wherein the name and/or logo are preferably provided using the font and color(s) provided in the branding guidelines for the institution) and/or textual information to be used in generating one or more user interfaces, such as a login card (described below), which is preferably configurable by the institution. Of course, the configuration set may include other types of information in accordance with the present invention. Configuration service 200 then transmits the configuration set for the institution (including any customized content retrieved from another database) back to the mobile application via API endpoint 200.

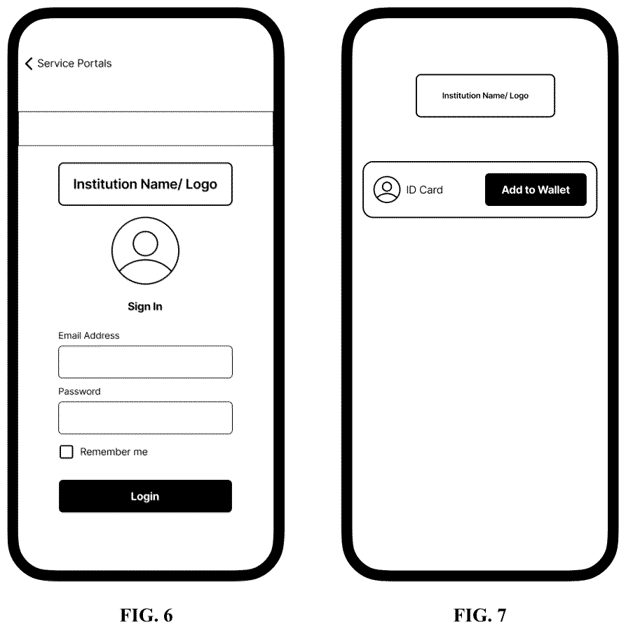

In step 312, the mobile application causes the mobile device to display a user interface that prompts the user to enter login credentials. In this embodiment, the mobile application generates the user interface based on a predetermined format that is used for all of the participating institutions. The predetermined format may include, for example, data entry fields for entering login credentials, such as a username and password. The mobile application also uses the customized content included in the configuration set received in step 310 to customize the user interface. An example of such a user interface is the login card shown in FIG. 6, which includes a placeholder for the institution's name and logo, a placeholder for the textual information, and data entry fields for the username and password. In step 314, the user enters his login credentials and selects the “Login” button shown in FIG. 6, whereby the mobile application receives the login credentials.

In step 316, the mobile application uses an API to pass the login credentials to an API endpoint of an institution directory service provided by the institution—i.e., the institution directory service functions as an identity service provider in this embodiment. Specifically, the mobile application uses the ID and URL of the identity service provider included in the configuration set received in step 310 to transmit an authentication request (e.g., a standard SAML2 authentication request) to the institution directory service of the applicable institution (i.e., one of institution systems 130₁-130ₙ). The institution directory service uses the login credentials to authenticate the user, which may involve any level of authentication required by the institution (e.g., verification of identity and multi-factor authentication). The institution directory service then returns to the mobile device an indication of whether the user was authenticated along with a token comprising user information associated with the login credentials. The user information may comprise, for example, an email address, a customer number, or any other information that identifies the user. The user information is then mapped to a user record that provides additional user information, such as the user's name, one or more identifiers (e.g., an ID card number, a student ID number, or both), and any other information required by the institution. In this embodiment, the user information in the user record is provided by the applicable institution and associated identity service provider for storage in database server 110 of the mobile credential management system 110. Of course, in other embodiments, the identity service provider may be a separate entity that provides authentication services on behalf of the institution.

In step 317, the mobile application uses an API to pass device information, institution information and user information to API endpoint 202 of configuration service 200 shown in FIG. 2. Configuration service 200 receives the device information from the mobile device and determines whether the device supports the mobile credential service. Configuration service 200 also receives the institution and user information from the mobile device and accesses configuration database 212 to retrieve an indication of whether the institution and user are both eligible for the mobile credential service.

In step 318, if the device, institution and user are all eligible for the mobile credential service, the mobile application causes the mobile device to display a user interface that prompts the user to begin the process of adding a mobile credential to a digital wallet of the mobile device (wherein there may be several digital wallets on the mobile device, as described below). An example of such a user interface is the card shown in FIG. 7, which includes an “Add to Wallet” button inviting the user to begin the process of adding the mobile credential (including one or more identifiers such as an ID card number, a student ID number, or both) to a digital wallet of the mobile device. In step 320, the user selects the “Add to Wallet” button shown in FIG. 7.

In step 322, the mobile application uses an API to pass mobile device information to API endpoint 206 of allowed wallets service 204 shown in FIG. 2. In this embodiment, the mobile device information identifies the platform, brand, model name/number, and country code of the mobile device (e.g., Android, Samsung, SM-S901U, US). Allowed wallets service 204 receives the mobile device information from the mobile device and accesses allowed wallets database 214 to retrieve wallet information corresponding to the mobile device information. In this embodiment, the wallet information identifies one or more wallet types (Google Wallet, Samsung Wallet, etc.) that are available for use on a mobile device having the device type. It should be understood that the number of wallet types will vary between different mobile devices—e.g., a mobile device may have one, two, three, four or more digital wallets in accordance with the present invention. In some embodiments, allowed wallets service 204 may also confirm that the institution has approved the use of each of the identified digital wallets (e.g., some institutions may not approve the use of one or more wallet types). For each of the identified digital wallets, the wallet information may also identify the platform, brand, model name/number, and country code of one or more additional device types associated with the mobile device (e.g. Android, Samsung, SM-R930U, US). For example, if the mobile device is a mobile phone, the additional device types may comprise one or more wearable computing devices associated with the mobile phone that support the use of a digital wallet.

In step 324, the mobile application causes the mobile device to display a user interface that lists the digital wallets for each supported wallet type as identified in step 322—i.e., the digital wallets to which a mobile credential may be added. An example of such a user interface is the card shown in FIG. 8, which enables a user to select between “Add to Wallet 1, “Add to Wallet 2,” “Add to Wallet 3,” and “Add to Wallet 4.” In step 326, the user selects one of the digital wallets listed in FIG. 8, whereby the mobile application receives the wallet selection. It can be appreciated that the user may have a preference for a particular digital wallet, such as in cases where a digital wallet provides coupons, discounts or other deals in connection with the purchase of goods or services. In some cases, the mobile application may be required to communicate with the operating system of the mobile device in order to request permission to communicate with the selected digital wallet, and the user may be required to allow this request. Of course, this step is not required if such permission has automatically been granted to the mobile application. It should be understood that steps 324 and 326 may not be performed if only one digital wallet is available for use on the mobile device.

In step 328, the mobile application performs a mobile device eligibility check to determine whether the mobile device is eligible to support the use of a mobile credential (although this step may not be required for certain mobile devices that do not require an eligibility check). To perform this check, the mobile application uses one or more APIs to pass the mobile device information (e.g., platform, brand, model name/number, and country code) to a third party (such as the original equipment manufacturer (OEM) vendor of the mobile device) and/or the wallet software on the mobile device in order to determine the eligibility of the mobile device (e.g., whether the mobile device is supported for provisioning the mobile credential in the digital wallet, whether the digital wallet is configured correctly, whether the user is signed in on the digital wallet, etc.), which returns an indication of whether the mobile device is eligible. If an error code is returned, the mobile application presents a help button with an explanation of why the mobile device is not eligible for provisioning the mobile credential and/or may provide instructions on how to correct the error. Otherwise, the method proceeds to step 330.

In step 330, if the mobile device (e.g., a smart phone) is associated with a wearable computing device (e.g., a smart watch), as identified in step 322, the mobile application performs a wearable eligibility check to determine whether the wearable computing device is eligible to support the use of a mobile credential (although this step may not be required for certain wearable computing devices that do not require an eligibility check). To perform this check, the mobile application uses one or more APIs to pass the wearable information (e.g., platform, brand, model name/number, and country code) to a third party (such as the original equipment manufacturer (OEM) vendor of the wearable computing device) and/or the wallet software on the wearable computing device in order to determine the eligibility of the wearable computing device (e.g., whether the wearable computing device is supported for provisioning the mobile credential in the digital wallet, whether the wearable computing device is paired to the mobile device, etc.), which returns an indication of whether the wearable computing device is eligible. If an error code is returned, the mobile application presents a help button with an explanation of why the wearable computing device is not eligible for provisioning the mobile credential and/or may provide instructions on how to correct the error. Otherwise, the method proceeds to step 332.

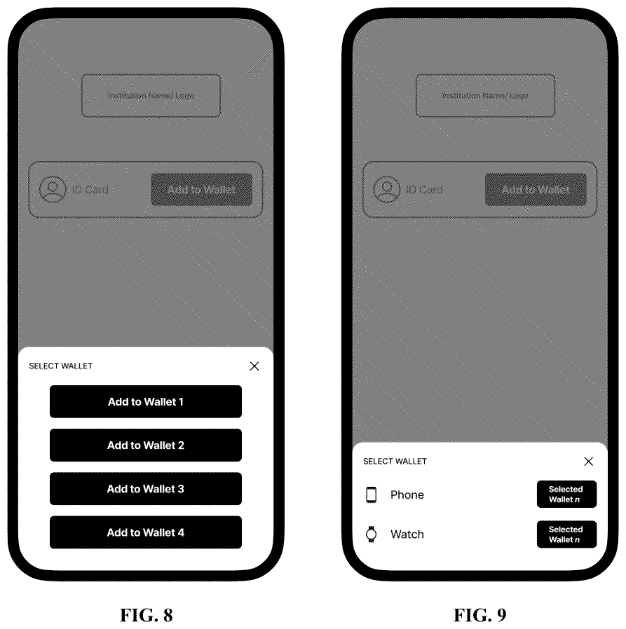

In step 332, the mobile device displays a user interface that prompts the user to select the mobile device to which the mobile credential should be added. If the mobile device (e.g., a smart phone) is associated with a wearable computing device (e.g., a smart watch), then both device options will be presented. Otherwise, just the mobile device option will be presented. An example of such a user interface is the card shown in FIG. 9, which invites the user to select either a phone or a watch. In step 334, the user selects one of the device options listed in FIG. 9, whereby the mobile application receives the device selection. This description will assume that the user selects the phone, but the watch could alternatively be selected by the user—i.e., the process is the same regardless of whether the phone or watch is selected.

It should be understood that further communication between the mobile application and the applicable digital wallet provider system (i.e., one of digital wallet provider systems 140₁-140ₙ) may be required for certain mobile devices. For example, in some cases, the mobile application uses an API to send a linking token request to the digital wallet provider system. Upon receipt of this request, the digital wallet provider system generates a linking token and returns it to the mobile application. In this embodiment, the linking token comprises a secure piece of data that allows subsequent payload data to be verified.

In step 336, the mobile application uses an API to pass enrollment information to API endpoint 210 of mobile device enrollment service 208 shown in FIG. 2. In this embodiment, the enrollment information comprises the following data: mobile credential identifier, institution identifier, customer identifier, card number, service portal identifier, external identifier, card number issue and expiry dates, device platform and device type (e.g., phone or watch), and metadata relating to serial numbers and whether it is a primary card in the wallet. Mobile device enrollment service 208 receives the enrollment information from the mobile device—and accesses mobile device enrollment database 216 to retrieve the information required to create a secure bundle of information needed to provision the mobile credential in the digital wallet of the mobile device wherein that information is referred to herein as “mobile credential data.” In some cases, at least a portion of the information may be retrieved from a third party (such as the original equipment manufacturer (OEM) vendor of the mobile device and/or one of digital wallet provider systems 140₁-140ₙ). Mobile device enrollment service 208 then creates the mobile credential data and transmits the mobile credential data back to the mobile application via API endpoint 210.

In this embodiment, the mobile credential data includes the one or more identifiers for the mobile credential (e.g., an ID card number, a student ID number, or both) and the information identifying the selected digital wallet of the selected mobile device (e.g., device ID, digital wallet ID, secure element ID, etc.), all of which are preferably encrypted. It should be understood that the one or more identifiers contained in the mobile credential data (which will ultimately be included in the mobile credential that is provisioned in the selected digital wallet of the selected mobile device) will vary between different institutions. Each institution will provide readers that are configured to read the appropriate identifier(s) once provisioned. Also, the mobile device information and digital wallet information contained in the mobile credential data will vary between different OEM vendors of mobile devices and different digital wallet provider systems, respectively. Other types of information may also be included in the mobile credential data in accordance with the present invention. For example, if the institution comprises a university, the mobile credential data may include information that will be used by the digital wallet to display the card with the appropriate logo, colors, user photo, and user name.

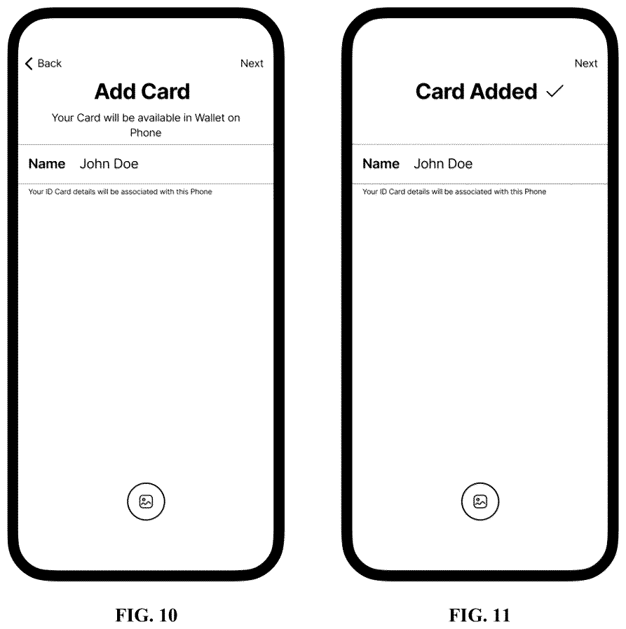

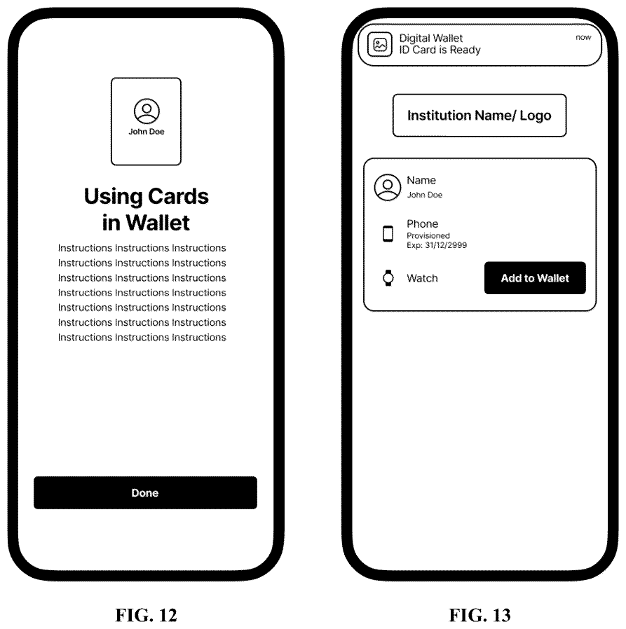

In step 338, the mobile application transmits the mobile credential data received in step 336 to the wallet software on the mobile device. At this point, the mobile application transfers control to the wallet software, which guides the process of provisioning the mobile credential in the digital wallet of the mobile device. The mobile device may display one or more additional user interfaces during the process of provisioning the mobile credential (e.g., an ID card), depending on the requirements of the wallet software. Examples of such user interfaces include: a card confirming that the ID card will be added to the phone (FIG. 10); a card providing the terms and conditions of use (wherein the user must select a button to agree to those terms and conditions); a card confirming that the ID card has been added to the phone (FIG. 11); and a card providing instructions on how the provisioned ID card may be used along with a “Done” button inviting the user to finish the process of adding the ID card to the phone (FIG. 12). When the user selects the “Done” button shown in FIG. 12, control is transferred from the wallet software back to the mobile application on the mobile phone.

In step 340, the mobile device displays a user interface indicating that the mobile credential has been provisioned in the digital wallet of the mobile device. An example of such a user interface is the card shown in FIG. 13, which shows that the ID card has been provisioned in the digital wallet of the phone. In this embodiment, the user may be permitted to add a mobile credential to the digital wallet of another mobile device (e.g., the user may want to add the ID card to a phone and a watch, to two different phones, etc.). For example, in FIG. 13, the card includes an “Add to Wallet” button that may be selected to add the ID card to the user's watch (in addition to the phone that has already been provisioned). One skilled in the art will appreciate that the provisioning process is then repeated for the additional mobile device.

In this embodiment, once the ID card has been provisioned in the digital wallet of a mobile device, the user can utilize the mobile device for access control (e.g., unlocking doors), payments from a stored value account (e.g., pre-paid meal plans or other prepaid goods and services), and/or any other tasks that require the use of an ID card. Preferably, the ID card is available for use even when the mobile device needs to be recharged. Also, the system preferably provides an option to remove the ID card from the digital wallet of the mobile device when no longer needed.

### ALTERNATIVE EMBODIMENTS

One skilled in the art will appreciate that the present invention is not limited to the system and method of the exemplary embodiment described above and that other embodiments are possible within the scope of the invention.

In one embodiment, the system and method described above is simplified where the mobile application is associated with a specific institution (and optional service portal) rather than being designed for use by multiple institutions. For example, if a mobile application is only used by one institution, certain functions supported by the mobile credential management system 110 could be hard-coded in the mobile application in order to simplify the provisioning process—i.e., the functions may either be hard-coded in the mobile application or provided to the mobile application via configuration in accordance with the invention.

In another embodiment, the system and method described above is modified so that the user interface that enables the user to select a mobile device from a plurality of mobile devices is displayed prior to the user interface that enables the user to select a digital wallet from a plurality of digital wallets. For example, the user interface shown in FIG. 9 may be displayed prior to the user interface shown in FIG. 8.

In another embodiment, the system and method described above is modified to provide a user interface that visually emphasizes a particular digital wallet for selection by the user. For example, the user interface shown in FIG. 8 may be modified so that one of the digital wallets is visually preferred over the others, such as through positioning of the digital wallet (e.g., placing the preferred digital wallet at the top of the list), prominence of the digital wallet (e.g., using a larger font, using a different font style, using a different color, etc. for the digital wallet), or other attention focusing mechanisms. As such, the user may be guided to select a digital wallet that is preferred by mobile credential management system 110 for business or other reasons.

In another embodiment, the system and method described above is modified to provide a user interface that visually emphasizes a particular mobile device for selection by the user. For example, the user interface shown in FIG. 9 may be modified so that one of the mobile devices (e.g., phone or watch) is visually preferred over the others, such as through positioning of the mobile device (e.g., placing the preferred mobile device at the top of the list), prominence of the mobile device (e.g., using a larger font, using a different font style, using a different color, etc. for the mobile device), or other attention focusing mechanisms. As such, the user may be guided to select a mobile device that is preferred by mobile credential management system 110 for business or other reasons.

In another embodiment, the system and method described above is modified to provide a user interface that highlights one or more capabilities that are not available to the user. For example, if the mobile device comprises a mobile phone that is not associated with an eligible wearable computing device, the user interface shown in FIG. 9 may be modified to show the phone option along with an indication that the user's watch does not support the provisioning of a mobile credential. The user interface may also identify other wearable computing devices (e.g., other watch models) that are supported. This may encourage the user to obtain a wearable computing device that supports the provisioning of a mobile credential.

In another embodiment, the system and method described above is modified to provide a user interface that enables a user to provision a mobile credential on a plurality of mobile devices, such as all available mobile devices. For example, the user interface shown in FIG. 9 may be modified to include a “Provision on All” button that enables the user to select both the phone and watch, in which case the mobile credential is provisioned separately on the phone and watch without further user interaction.

In yet another embodiment, the system and method described above is modified to provide a user interface that enables the mobile credential to be provisioned into a preferred digital wallet. For example, the user interface shown in FIG. 8 may be modified to include a “Make the Choice for Me” button that, if selected by the user, would result in auto-selection of the preferred digital wallet. Alternatively, the user interface shown in FIG. 8 may be modified so that it does not present all of the available digital wallets—e.g., it may only present the preferred digital wallet option. As such, the preferred digital wallet may be selected by mobile credential management system 110 for business or other reasons.

One skilled in the art will appreciate that the present invention may be used by any institution in which users have a need to provision mobile credentials in selected digital wallets of one or more mobile devices. For example, the institution may comprise a university in which students and employees can use their provisioned mobile devices to unlock doors of campus buildings, purchase food on pre-paid meal plans or from vending machines, access laundry services, or perform any other tasks that require the use of a campus ID card. As another example, the institution may comprise a hotel in which hotel guests can use their provisioned mobile devices to unlock doors at the hotel or purchase snacks, movies, etc. As another example, the institution may comprise a hospital or any other business in which users can use their provisioned mobile devices to navigate through secure access points. As another example, the institution may comprise the provider of a mobile application that enables users to rent or lease houses, rooms, vehicles, or other access-controlled spaces, wherein users can use their provisioned mobile devices as digital keys to access such spaces. As another example, the institution may comprise a theme park in which users can use their provisioned mobile devices as digital keys to access rides/features while avoiding long lines. As yet another example, the institution may comprise an entity that provides security-related services at airports (e.g., TSA Pre-Check®, NEXUS, CLEAR, etc.), wherein users can use their provisioned mobile devices to expedite screening at airport security lines. Of course, other implementations will be apparent to one skilled in the art.

### General Information

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

The use of relative relational terms, such as first and second, are used solely to distinguish one unit or action from another unit or action without necessarily requiring or implying any actual such relationship or order between such units or actions.

Finally, while the present invention has been described and illustrated hereinabove with reference to various exemplary embodiments, it should be understood that various modifications could be made to these embodiments without departing from the scope of the invention. Therefore, the present invention is not to be limited to the specific systems or methodologies of the exemplary embodiments, except insofar as such limitations are included in the following claims.

What is claimed and desired to be secured by Letters Patent is as follows:

1. A non-transitory computer readable medium storing instructions that, when executed by one or more processors of a mobile device, cause the one or more processors to perform a plurality of operations comprising:
identifying a plurality of digital wallets available for use on the mobile device;
displaying a user interface that presents a plurality of digital wallet options each of which corresponds to one of the identified digital wallets;
receiving a selection of a digital wallet from the digital wallet options; and
creating mobile credential data that enables provisioning of a mobile credential in the selected digital wallet of the mobile device.

2. The non-transitory computer readable medium of claim 1, wherein the mobile device comprises one of a mobile phone, a wearable computing device, or a personal computing tablet.

3. The non-transitory computer readable medium of claim 1, wherein identifying the plurality of digital wallets available for use on the mobile device comprises:
using an application programming interface (API) to pass a device type for the mobile device to an API endpoint of an allowed wallets service, wherein the allowed wallets service responds by providing the digital wallets available for use on a mobile device having the device type.

4. The non-transitory computer readable medium of claim 1, wherein the user interface presents the wallet options so as to visually emphasize a preferred one of the wallet options.

5. The non-transitory computer readable medium of claim 1, wherein the user interface presents an additional option to enable auto-selection of the digital wallet from the digital wallet options, wherein the auto-selected digital wallet comprises a preferred one of the wallet options.

6. The non-transitory computer readable medium of claim 1, wherein the instructions comprise a full mobile application.

7. The non-transitory computer readable medium of claim 1, wherein the instructions comprise a micro application.

8. The non-transitory computer readable medium of claim 1, wherein the instructions are configured for use by a plurality of users to provision a plurality of respective mobile credentials associated with a single institution.

9. The non-transitory computer readable medium of claim 1, wherein the instructions are configured for use by a plurality of users to provision a plurality of respective mobile credentials associated with a plurality of different institutions.

10. A non-transitory computer readable medium storing instructions that, when executed by one or more processors of a mobile device, cause the one or more processors to perform a plurality of operations comprising:
identifying a plurality of digital wallets available for use on the mobile device;
displaying a first user interface that presents a plurality of digital wallet options each of which corresponds to one of the identified digital wallets;
receiving a selection of a digital wallet from the digital wallet options;
identifying a plurality of device types associated with the mobile device;
displaying a second user interface that presents a plurality of device options each of which corresponds to one of the identified device types;
receiving a selection of a device from the device options; and
creating mobile credential data that enables provisioning of a mobile credential in the selected digital wallet of the selected device.

11. The non-transitory computer readable medium of claim 10, wherein the mobile device comprises one of a mobile phone, a wearable computing device, or a personal computing tablet.

12. The non-transitory computer readable medium of claim 10, wherein the device options comprise the mobile device and at least a second mobile device, wherein the selected device comprises the mobile device, and wherein the mobile credential data is created to enable provisioning of the mobile credential in the selected digital wallet of the mobile device.

13. The non-transitory computer readable medium of claim 10, wherein the device options comprise the mobile device and at least a second mobile device, wherein the selected device comprises the second mobile device, and wherein the mobile credential data is created to enable provisioning of the mobile credential in the selected digital wallet of the second mobile device.

14. The non-transitory computer readable medium of claim 10, wherein the device options comprise the mobile device and at least a second mobile device, wherein receiving the selection of the device from the device options comprises (a) receiving a first selection comprising the mobile device and (b) receiving a second selection comprising the second mobile device, and wherein creating mobile credential data that enables provisioning of the mobile credential in the selected digital wallet of the selected device comprises (a) creating first mobile credential data that enables provisioning of the mobile credential in the selected digital wallet of the mobile device and (b) creating second mobile credential data that enables provisioning of the mobile credential in the selected digital wallet of the second mobile device.

15. The non-transitory computer readable medium of claim 10, wherein identifying the plurality of digital wallets available for use on the mobile device comprises:
using an application programming interface (API) to pass a device type for the mobile device to an API endpoint of an allowed wallets service, wherein the allowed wallets service responds by providing the digital wallets available for use on a mobile device having the device type.

16. The non-transitory computer readable medium of claim 10, wherein identifying the plurality of device types associated with the mobile device comprises:
using an application programming interface (API) to pass a device type for the mobile device to an API endpoint of an allowed wallets service, wherein the allowed wallets service responds by providing one or more additional device types associated with the mobile device for at least one of the identified digital wallets.

17. The non-transitory computer readable medium of claim 10, wherein the first user interface presents the wallet options so as to visually emphasize a preferred one of the wallet options.

18. The non-transitory computer readable medium of claim 10, wherein the first user interface presents an additional option to enable auto-selection of the digital wallet from the digital wallet options, wherein the auto-selected digital wallet comprises a preferred one of the wallet options.

19. The non-transitory computer readable medium of claim 10, wherein the second user interface presents the device options so as to visually emphasize a preferred one of the device options.

20. The non-transitory computer readable medium of claim 10, wherein the first user interface is displayed to present the wallet options prior to the second user interface is displayed to present the device options.

21. The non-transitory computer readable medium of claim 10, wherein the second user interface is displayed to preset the device options prior to the first user interface is displayed to present the wallet options.

22. The non-transitory computer readable medium of claim 10, wherein the instructions comprise a full mobile application.

23. The non-transitory computer readable medium of claim 10, wherein the instructions comprise a micro application.

24. The non-transitory computer readable medium of claim 10, wherein the instructions are configured for use by a plurality of users to provision a plurality of respective mobile credentials associated with a single institution.

25. The non-transitory computer readable medium of claim 10, wherein the instructions are configured for use by a plurality of users to provision a plurality of respective mobile credentials associated with a plurality of different institutions.

26. A non-transitory computer readable medium storing instructions that, when executed by one or more processors of a mobile device, cause the one or more processors to perform a plurality of operations comprising:
providing a plurality of digital wallet options;
receiving a selection of a digital wallet from the digital wallet options;
providing a plurality of device options;
receiving a selection of a device from the device options; and
creating mobile credential data that enables provisioning of a mobile credential in the selected digital wallet of the selected device.

27. The non-transitory computer readable medium of claim 26, wherein the mobile device comprises one of a mobile phone, a wearable computing device, or a personal computing tablet.

28. The non-transitory computer readable medium of claim 26, wherein the instructions comprise a full mobile application.

29. The non-transitory computer readable medium of claim 26, wherein the instructions comprise a micro application.

30. The non-transitory computer readable medium of claim 26, wherein the instructions are configured for use by a plurality of users to provision a plurality of respective mobile credentials associated with a single institution.

31. The non-transitory computer readable medium of claim 26, wherein the instructions are configured for use by a plurality of users to provision a plurality of respective mobile credentials associated with a plurality of different institutions.
